(19) United States
(12) Patent Application Publication
(10) Pub. No.: US 2010/0199823 A1
(43) Pub. Date: Aug. 12, 2010

(54) Pusher for feeding items through an opening such as in a food processing device

(76) Inventors: Enrico Dalla Piazza, Schneisingen (CH); Edward H. Kilduff, New York, NY (US); Matthew L. Chin, New York, NY (US)

Correspondence Address: Thomas J. Brindisi, Esq., 20 28th Place, Suite B, Venice, CA, 90291, US

(21) Appl. No.: 12/658,527

(22) Filed: Feb. 10, 2010

Related U.S. Application Data
(60) Provisional application No. 61/207,419, filed on Feb. 11, 2009.

(51) Int. Cl. B26D 7/06

(52) U.S. Cl. 83/437.2

(57) ABSTRACT

Disclosed is a pusher for feeding items through an opening such as in a food processing device in which the opening has an annular top surface and communicates with a port space adjacent a second surface, and in which the opening, annular top surface, and port space can be moved together with respect to the second surface. The pusher comprises a lip that is substantially inflexible and shaped to rotatably mate with the annular top surface on a low-friction surface, and it comprises a flexible mitten connected to the lip and having a finger space that terminates in a fingers-tip and a thumb space that terminates in a thumb-tip.

### RELATED APPLICATION

This application claims the benefit of U.S. provisional patent application Ser. No. 61/207,419 filed Feb. 11, 2009 and entitled “Pusher For Feeding Items Through An Opening Such As In A Food Processing Device.”

### FIELD OF THE INVENTION

The present invention relates to devices for feeding items through an opening, and more particularly, to a pusher for feeding items through an opening such as in a food processing device.

### BRIEF DESCRIPTION OF THE DRAWINGS

FIG. 1 is a partial perspective view of a mandolin slicer for use with an embodiment of a pusher according to the present invention, with the mandolin slicer's sliding cover rendered transparently.

FIG. 2 is an exploded perspective view of the mandolin slicer of FIG. 1, and an embodiment according to the present invention of a pusher for use therewith.

FIG. 3 is a cutaway view of the sliding cover and pusher of FIGS. 1 & 2, with the pusher fully inserted into the sliding cover's port.

### DETAILED DESCRIPTION OF A PREFERRED EMBODIMENT

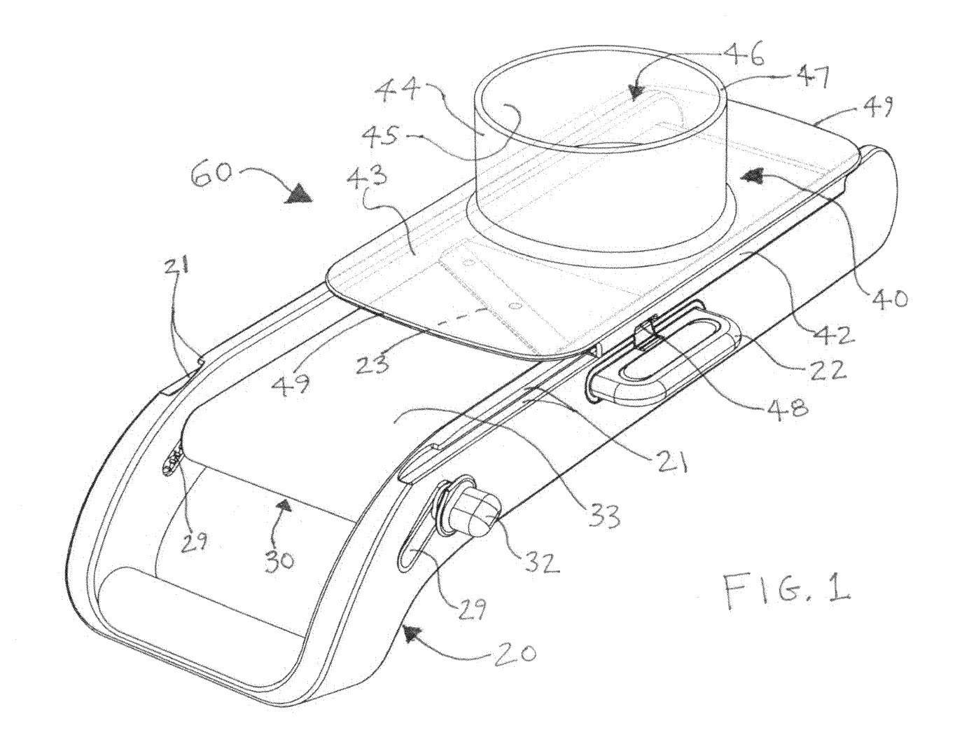

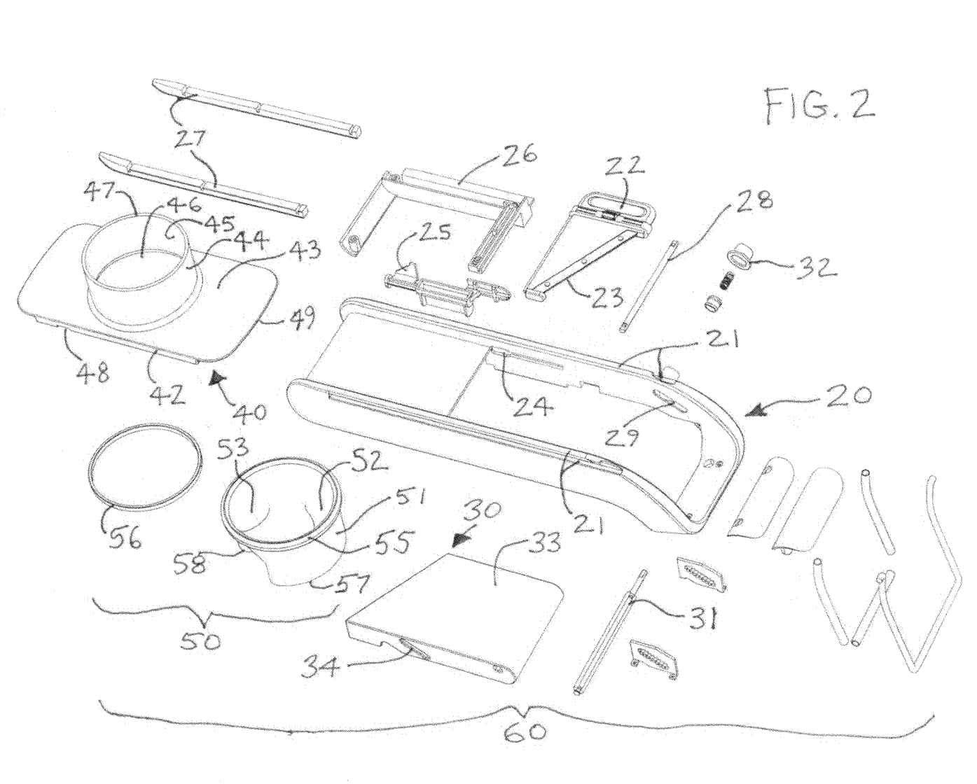

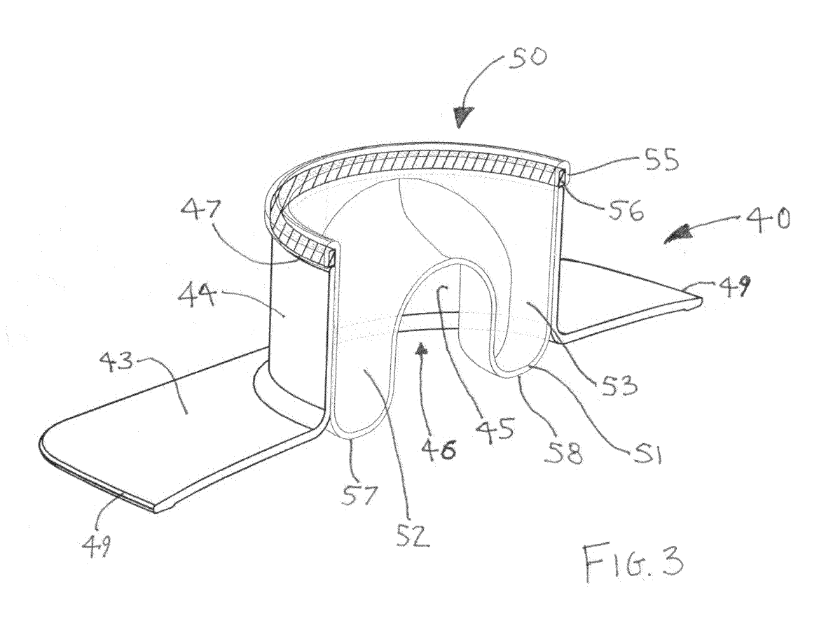

FIGS. 1-3 depict an embodiment of a pusher 50 according to the present invention, for feeding items through an opening such as in a food processing device. As shown in FIGS. 1 and 2, the pusher 50 comprises a mitten 51 having a four-finger space 52 and a thumb space 53 designed to receive the corresponding parts of a hand (thus four-finger space 52 is significantly wider than thumb space 53), preferably with enough space to comfortably or snugly accommodate a somewhat larger than average hand. The mitten 51 is preferably flexible and thin enough to allow a user to manipulate it sufficiently to grasp items at least partially and/or feel items to some degree through the mitten 51. The mitten 51 is thus made of a durable and resilient but flexible material such as a suitable silicone, synthetic rubber, Croslite® EVA, et cetera, with a thickness of about, e.g., 3 mm. The mitten's fingers-tip 57 and thumb-tip 58 (or else the entire mitten 51) may be internally and/or externally reinforced (not shown) with a stronger material such as a fine wire mesh or a highly durable (e.g., nylon fiber) fabric. The outer surface of the fingers-tip 57 and thumb-tip 58 may also include a grip-enhancing layer (not shown) such as a higher-friction coating, protuberances, or other gripping means. The top of the pusher 50 preferably includes a lip 55 that is interiorly fitted (e.g., by co-injection molding) with a low-friction, stiff, durable, and hard (e.g., nylon) ring 56, which reinforces and prevents the top of the mitten 51 from being squeezed inwardly, and which (see FIG. 1) can serve as a bearing against the annular top surface 47 of the port 44, described below.

Referring now to FIGS. 1 and 2, operation of the present illustrative embodiment of the invention in the context of use with a mandolin slicer 60 is described. Mandolin slicers are well known, so their details unrelated to the pusher 50 are described here only cursorily. An exemplary mandolin slicer 60 comprises a body 20, an infeed plate 30, and a sliding cover 40. The body 20 includes track guides 21 and the sliding cover 40 includes corresponding running tracks 42, so that the sliding cover 40 is free to be moved forward and backward by a user. In that regard, U.S. Pat. No. 7,331,538 issued to Menze and licensed to Applicant is incorporated herein by reference for its disclosure of a sliding attachment on guide rails. The sliding cover 42 of the illustrated mandolin slicer 60 has a slightly convex cover 43 at the center of which is a port 44.

The body 20 further includes a blade insertion slot 24 through which the user can install and remove a removable blade assembly 22 having a cutting edge 23, and includes a spring-loaded blade blocker 25 (in that regard, U.S. Pat. No. 7,331,538 issued to Menze and licensed to Applicant is incorporated herein by reference for its disclosure of a safety holder). The sliding cover 40 is generally symmetric and its running tracks 42 include diagonally symmetric blade release notches 48 so that the sliding cover 40 can be taken off and put back on the body 20 in either direction (i.e., the leading/trailing edges 49 can be reversed). The front of the body 20 is supported by front support rib 26 and front support skids 27, which may be made of a strong and durable, non-marking material.

An infeed plate 30 is adjustably secured to the body 20 by a front bar 28 that is affixed to the body 20 and runs through diagonal slots 34 in the infeed plate 30, and by a height-adjustable rear bar 31 that is affixed to the infeed plate 30 and runs through diagonal slots 29 in the body 20. The height of the infeed plate 30 can be adjusted by engaging the adjustment button 32, which permits the user to select and then lock down a different position of the bars 28 and 31 within their respective slots 34 and 29 translating the infeed plate 30 to a different height. Thus, the sliding cover 40 can be moved forward and backward on the body 20, with its port 44 introducing items to be slid against the top surface 33 of the infeed plate 30 for slicing on cutting edge 23, with cut thickness determined by the height of the infeed plate 30 selected as described above.

The pusher 50 is used to introduce and feed items through the port 44, and in the embodiment illustrated is not attached to the port 44 (although optionally it could be). The outer surface of the mitten 51 preferably fits closely within the port's interior surface 45 so as to align the pusher 50, but not so close as to unduly hamper rotation or pushing; e.g., with a 2 mm separation between the mitten 51 and interior surface 45 at each side when the pusher 50 is fully inserted. The pusher 50 can be rotated arbitrarily by a user gripping the item with the mitten 51 and advancing it down progressively during slicing. When the pusher 50 reaches full insertion into the port space 46, the ring 56 bears against the annular top surface 47 of the port 44, preventing the mitten 51 from moving further down through the port space, and acting as a bearing to the extent that the user rotates the pusher 50 within port 44 (such as to optimize slicing by rotating the item with tactile feedback as it is cut). When the pusher 50 is fully inserted into the port 44, the ends of fingers-tip 57 and thumb-tip 58 are separated by a minimum distance, e.g., 1.5 cm, from the cutting edge 23, and the material and thickness of the mitten 51 is chosen, or is reinforced against stretching, such that the ends of fingers-tip 57 and thumb-tip 58 resist being stretched downwardly enough to significantly reduce that minimum separation.

Although the present invention has been described in detail in the context of a preferred embodiment of a pusher for feeding items through an opening such as in a food processing device, one skilled in the art will appreciate that numerous variations, modifications, and other applications are also within the scope of the present invention. As an example, a pusher according to the present invention could be made for use with an electric food processor with a widened feed tube. Thus, the foregoing detailed description is not intended to limit the invention in any way, which is limited only by the following claims and their legal equivalents.

What is claimed is:

1. A pusher for feeding items through an opening such as in a food processing device, wherein the opening is defined at its top by an annular top surface and communicates with a port space that is adjacent a second surface, and wherein the opening, annular top surface, and port space are together capable of being moved with respect to said second surface, the pusher comprising a lip that is substantially inflexible and shaped to rotatably mate with the annular top surface, said lip having a low-friction surface formed to contact said annular top surface, the pusher further comprising a flexible mitten connected to said lip, said flexible mitten having a finger space terminating in a fingers-tip and a thumb space terminating in a thumb-tip.
